(19) United States
(12) Patent Application Publication
(10) Pub. No.: US 2014/0258009 A1
(43) Pub. Date: Sep. 11, 2014

(54) PAYMENT SERVICE REGISTRATION

(71) Applicant: MOBIbucks Corp., Sunnyvale, CA (US)

(72) Inventors: Ziad Alshobaki, Dubai (AE); Jorge M. Fernandes, Los Altos, CA (US)

(73) Assignee: MOBIbucks Corp., Sunnyvale, CA (US)

(21) Appl. No.: 13/957,246

(22) Filed: Aug. 1, 2013

Related U.S. Application Data
(63) Continuation-in-part of application No. 13/786,408, filed on Mar. 5, 2013.

(51) Int. Cl. G06Q 20/40; G06Q 20/20

(52) U.S. Cl. CPC G06Q 20/4012; G06Q 20/206
USPC 705/18

(57) ABSTRACT

Processes are disclosed to facilitate the verification and registration of users of a payment service. One process includes receiving an intent to register message from a user via an SMS message sent from a user mobile device. The process also includes sending a query message to the user mobile device. The query message includes a request for a government identification number from the user. The process also includes verifying the government identification number against a collection of data entries provided by a third party. The process also includes sending a temporary validation code to the user mobile device. The process also includes receiving an updated PIN from a known POS terminal. The known POS terminal was previously registered with the payment service. The updated PIN replaces the temporary validation code. The process also includes sending a registration confirmation to the user mobile device. Other related processes are also disclosed herein.

### CROSS-REFERENCE TO RELATED APPLICATION

This application is a continuation-in-part application of application Ser. No. 13/786,408, filed Mar. 5, 2013, which is incorporated herein by reference in its entirety.

### BACKGROUND

Access to reliable and inexpensive banking and payment services is important for the advancement of developing economies and for decreasing the cost of processing payments in the developed world as well. According to the International Monetary Fund's Financial Access Survey, numerous countries in the world have less than a quarter of their gross domestic product matched by outstanding deposits with commercial banks. In many of these countries, available payment processing services are prohibitively expensive for daily commercial life or are completely unavailable due to the lack of payment processing infrastructure. Furthermore, regardless of the presence or absence of adequate infrastructure for traditional payment processing methods, payment processing consumes a percentage of nearly every commercial transaction, and thereby represents a drain on both developed and developing economies alike.

Registering new users is a cost critical endeavor for the administration of a payment service. First, as the number of users increases, the fixed costs of administrating a payment service decreases. Therefore, to the extent a more fluid registration system facilitates an increase in the number of registered users of a payment service, the per user cost of administrating the payment service also decreases. Secondly, registering new users exposes a payment service to the cost of fraudulent registrations. If proper care is not taken to verify the identity of a new user, fraudulent transfers can be made using the payment service that negatively impact payment processors through the direct monetary loss of the fraudulent transfer as well as the indirect costs of a loss of trust in the payment service. Finally, registering new users can be costly to the payment service as verifying new customers generally requires the time and attention of paid employees of the payment service, and costly to potential users of the system as they incur the stress and time consumption associated with navigating the verification and approval process of the payment service.

Traditionally, an account at a financial institution, such as a bank account, has certain fixed limitations on transactions that can be performed on it. Certain accounts, for example, may limit ATM cash withdrawals to $300 total per day. For transactions that fall outside the limitations, the account holder may be required to go through extra verification procedures. For example, for a cash withdrawal greater than $300, the account holder may be required to show a form of photo identification (for example, a driver's license) to a teller at a bank branch.

Typically, the account holder must go through these extra verification procedures every time a transaction falls outside the account's fixed limitations. Moreover, usually the account holder has no control over the fixed limitations—they are pre-set by the financial institution.

### SUMMARY

A process for facilitating the registration of a user of a payment service is provided. The process includes receiving an intent to register message from a user via an SMS message sent from a user mobile device. The user mobile device is associated with the user. The process also includes sending a query message to the user mobile device. The query message includes a request for a government identification number from the user. The process also includes verifying the government identification number against a collection of data entries provided by a third party. The process also includes sending a temporary validation code to the user mobile device. The process also includes receiving an updated PIN from a known POS terminal. The known POS terminal was previously registered with the payment service. The updated PIN replaces the temporary validation code. The process also includes sending a registration confirmation to the user mobile device.

A process for verifying a user for a payment system is also provided. The process includes receiving an intent to register message from a user mobile device via a text message system. The user mobile device is associated with a user. The process also includes calling the user to obtain know your customer details. The process also includes registering the user using for the payment system using the know your customer details. The process also includes sending a temporary validation code to the user mobile device. The process also includes receiving the temporary validation code from the user via a preapproved point of sale terminal. The process also includes sending at least a portion of the know your customer details to the preapproved point of sale terminal. The process also includes receiving a verification from a terminal operator via the preapproved point of sale terminal. The verification confirms that the user matches the know your customer details.

A process for registering a group of users for a payment service is also provided. The process includes receiving a bulk upload of user identification information for said group of users from a payment service participant financial institution. The user identification information includes a set of mobile phone numbers. The process also includes sending a temporary validation code to said users via a text message using said mobile phone numbers. The process also includes receiving said temporary validation code via a point of sale terminal. The process also includes registering said user for said payment system. The process also includes receiving a permanent identification code for said user to operate said payment system via said point of sale terminal.

### BRIEF DESCRIPTION OF THE DRAWINGS

FIG. 1 is a block diagram of an account configuration system according to an embodiment of the present invention.

FIG. 2 is a flowchart of an account configuration method according to an embodiment of the present invention.

FIG. 3 is a block diagram of an account configuration system using an outside source of verification information, according to an embodiment of the present invention.

FIG. 4 is a flowchart of an account configuration method using an outside source of verification information, according to an embodiment of the present invention.

FIG. 5 is a flowchart of an account configuration or modification method, according to an embodiment of the present invention.

FIG. 6 is a flowchart of an account modification method using account data, according to an embodiment of the present invention.

FIG. 7 is a flowchart of an account configuration method, with a subsequent transaction method included, according to an embodiment of the present invention.

FIG. 8 is a flowchart of an account configuration method, with a subsequent mobile-phone-initiated transaction method included, according to an embodiment of the present invention.

FIG. 9 is a block diagram of a point-of-sale transaction system using a configured account, according to an embodiment of the present invention.

FIG. 10 is a block diagram of an online sale transaction system using a configured account, according to an embodiment of the present invention.

FIG. 11 is a block diagram of a peer-to-peer transaction system using a configured account, according to an embodiment of the present invention.

FIG. 12 is a flowchart of a method for registering a user with a payment service according to embodiments of the present invention.

FIG. 13 is a flowchart of a method for registering a user with a payment service involving placing a telephone call to the user according to embodiments of the present invention.

FIG. 14 is an operational flow diagram illustrating a registration operation involving a telephone call by a live customer service representative to a potential user of a payment service according to embodiments of the present invention.

FIG. 15 is an operational diagram illustrating a registration operation involving a telephone call by an automated service to a potential user of a payment service according to embodiments of the present invention.

FIG. 16 is a flowchart of a method for registering potential users of a payment service using a bulk upload of information from a financial institution according to embodiments of the present invention.

FIG. 17 is an operational diagram illustrating a second phase of a registration procedure according to embodiments of the present invention.

### DETAILED DESCRIPTION

The present disclosure relates to accounts used for monetary transactions. In particular, the present disclosure relates to configuring such an account.

Described herein are methods of creation and use of a type of financial transaction account that may be subject to transaction limitations. The financial transaction account can be created using a system having low overhead costs, minimal time commitment from the user, and widely available technology. The transaction limitations can be customized by the account holder, using pre-authorization techniques. This type of financial account may be associated with cash, credit, securities, or the like. In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

In this document, various computer-implemented methods, processes and procedures are described. It is to be understood that the various actions (receiving, storing, sending, communicating, displaying, etc.) are performed by a hardware device, even if the action may be authorized, initiated or triggered by a user, or even if the hardware device is controlled by a computer program, software, firmware, etc. Further, it is to be understood that the hardware device is operating on data, even if the data may represent concepts or real-world objects, thus the explicit labeling as “data” as such is omitted. For example, when the hardware device is described as “storing a record”, it is to be understood that the hardware device is storing data that represents the record.

As described above, for a typical account at a financial institution, transactions that fall outside certain limits often require extra levels of identity verification. The account holder must provide this extra verification each time such a transaction is requested. The embodiments described below obviate the need for this extra effort while still maintaining security for both the account holder and the financial institution. Transactions are thus streamlined. Also, the embodiments described below allow the account holder to have some input into the limitations placed on his accounts, while maintaining security for the account holder and the financial institution, and ensuring compliance with all appropriate financial regulations.

In one embodiment, an account has extra verification data associated with it. This data is stored and then keyed to more compact verification information—for example, to a mobile phone number and/or a user-defined personal identification number (PIN). The account holder can then perform transactions that would normally require extra identification procedures simply by providing this compact verification information.

In general, the account described herein is a regular bank account, possibly with added features. The account described herein may also be similar to the MOBI account, described in U.S. Patent Publication No. 2009/0024533 A1 for “Payment Systems and Methods” filed Aug. 29, 2007, or U.S. patent application Ser. No. 13/755,421 for “Self-authenticating peer-to-peer transaction” filed Jan. 31, 2013, both of which are owned by the assignee of the present invention, and both are incorporated by reference herein in their entirety.

The extra verification data provided at account configuration may also be required to satisfy various “know your customer” (KYC) regulations. These are regulations regarding which forms of identification are acceptable for various transactions. For example, these regulations may stipulate that customers wishing to make higher value transactions must present more secure forms of identity verification.

The configuration methods described herein are not limited to new accounts; existing accounts can be reconfigured using the same methods. The account holder may change the extra verification data associated with the account, and/or the limitations associated with the account may change automatically based on account usage data.

In the following descriptions, it is understood that all messages involved can be sent via a number of means; for example, wired or wireless voice or data channels, or the like. These means may be private or explicitly secure communication means; for example, encrypted voice or data channels, or the like. Communication means include (i) messages to and/or from a mobile device such as email messages, voice calls, data messages, text messages, messages sent via other applications (e.g., Facebook, Linked In, Skype and the like) and (ii) the same sort of messages sent to and/or from a stationary device such as a desktop computer or browser running on a television.

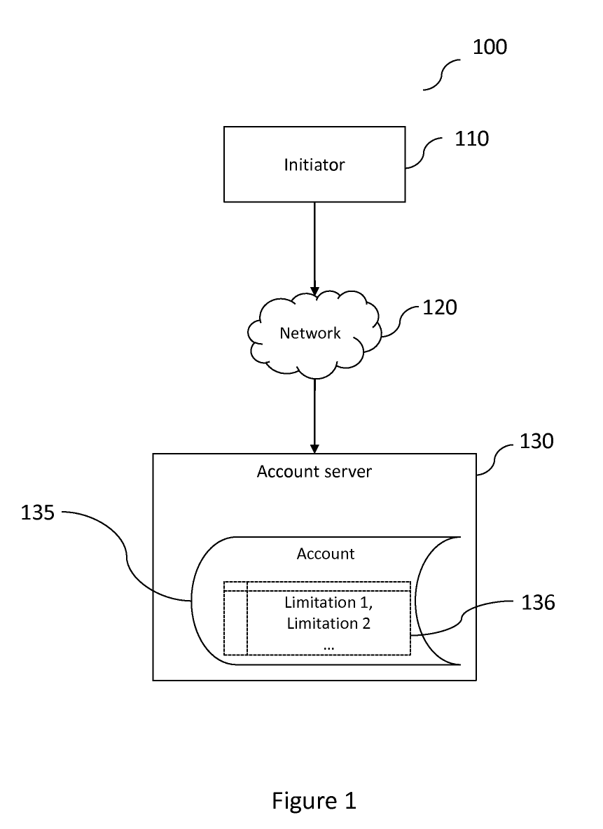

FIG. 1 shows a block diagram 100 exemplary of an embodiment of this invention. An initiator 110—for example, a user who wants to open a new account or re-configure an existing account—communicates with an account server 130 through a network 120 via any of a number of communication means. The network 120 could be, for example, the Internet. The account server 130 maintains an account 135. The account 135 is configured with one or more limitations 136 associated with later transactions. These limitations 136 will be compared with data from the later transactions in order to allow or deny the processing of the transaction.

There are many examples of limitations 136 that could be associated with the account 135. Such examples include, but are not limited to, a maximum limit on cash withdrawals, or a maximum limit on purchases, or other maximum transaction limits; limitations on currencies in which transactions may be denominated; or limitations on transaction types (for example, on-line purchases may restricted, but point-of-sale purchases may be allowed). Other examples include: maximum deposit limits, limitations on the number of transactions in a given time period (e.g., day, week, or month), restrictions on the location of the transaction, restriction on type of item or service purchased, or a restriction on people to whom cash is sent.

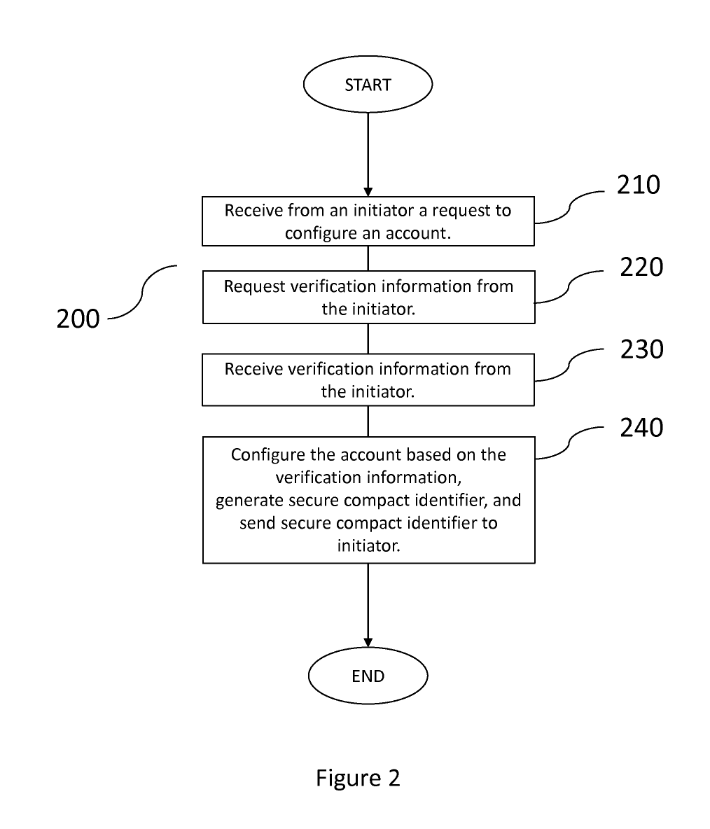

FIG. 2 shows a flowchart 200 of an account configuration process. The process represented by flowchart 200 may be implemented via a telephone call (to an automated voice system, for example), or a series of text messages, or a web site on a mobile or stationary device, or interactively through a bank branch or financial institution office, or at a merchant point-of-sale (POS), or any combination of these. In step 210 of flowchart 200, the account server 130 receives from the initiator 110 a request to configure an account 135. This request may be sent, for example, from an Internet-connected mobile or stationary device, via a web site form; it may also be sent via a text message or a phone call from a mobile device, for example, to an automated voice interactive system. In step 220, the account server 130 sends a request to the initiator 110 for verification information. The request sent in step 220 may be in the form of, for example, a list or menu of different verification options and the account limitations to which they correspond. Such a menu may be presented, for example, on a web page, or as part of an automated voice system (in the case where the operation is taking place over the phone), or interactively, by a merchant at a POS, or an agent at a bank. For example, one menu option may be to type in an existing PIN, corresponding to an account maximum transaction limit of $100, or $300; another option may be to scan or photograph an identifying document, such as a passport or driver's license, to enable a higher account transaction maximum (for example, $500, or $1000, or $1500). Other examples of verification information include a series of identifying questions presented to the initiator, an account number of a second account (which has, for example, already been configured), a photograph of the initiator, a government-issued identifier, or a trusted-source issued identifier.

Other identity verification information options may also be presented; for example, biometric information, such as fingerprint or retinal scans. This type of verification information may allow even higher transaction limits, for example, $5000 or $10,000. Different combinations of options may be available for different limitations—for example, both photo ID's and biometric information may be required for transactions involving certain currencies. Also, different levels may be set for different types of transactions; for example, a user may want to configure an account for a $500 purchase limit but a $100 cash withdrawal limit. In this way, an account may be configured with multiple limitations. Other limitation combinations—for example, limitations consistent with KYC regulations—may be available. Transactions on the account may still be subject to some limitations that are not based on the initiator's configuration choices; for example, a total cash withdrawal limit of $1000 per day may be fixed by the financial institution and not be configurable. The account server 130 may also request, in step 220, the initiator's mobile phone number, which may serve as part of the initiator's identification for each later transaction.

In step 230 of FIG. 2, the account server 130 receives the verification information from the initiator 110. This step may comprise, for example, the initiator choosing from the menu of different verification options, and then providing the information associated with that option. For example, the initiator may choose to provide an image of her passport, for a maximum transaction limit of $1000. The initiator then can submit an image of the required document; for example, by scanning it, or taking a picture of it with her mobile phone camera, or with a web camera attached to or embedded in a stationary computer. Also, the initiator may send the image via a postal service, or may show it to an authorized agent.

The verification information requested may require specialized hardware to submit; for example, a fingerprint scanner. In this case, the initiator may visit an office, such as a bank branch, to complete the configuration procedure.

In step 240 of FIG. 2, the account server 130 configures the account 135 based on the verification information acquired in step 230. This step may comprise, for example, storing the received verification information and associated transaction limitations in a secure storage area, and/or generating a secure compact identifier, such as a PIN, that the initiator will use (along with, for example, his mobile phone number) for identity verification for each later transaction. The secure PIN may be sent to the initiator, for example, via physical mail (e.g., U.S. Postal Service), or it may be given to the initiator if he is in a bank branch office or POS. Alternatively, the server may request the initiator to select a secure PIN. This request may be sent by any of the means discussed above: web site, phone call/voice message system, text message, or interactively at a POS or office, and the like. The initiator may respond with the secure PIN using similar communication means. The server may optionally send the initiator a temporary validation code (or temporary PIN) to use while waiting to receive the permanent secure PIN.

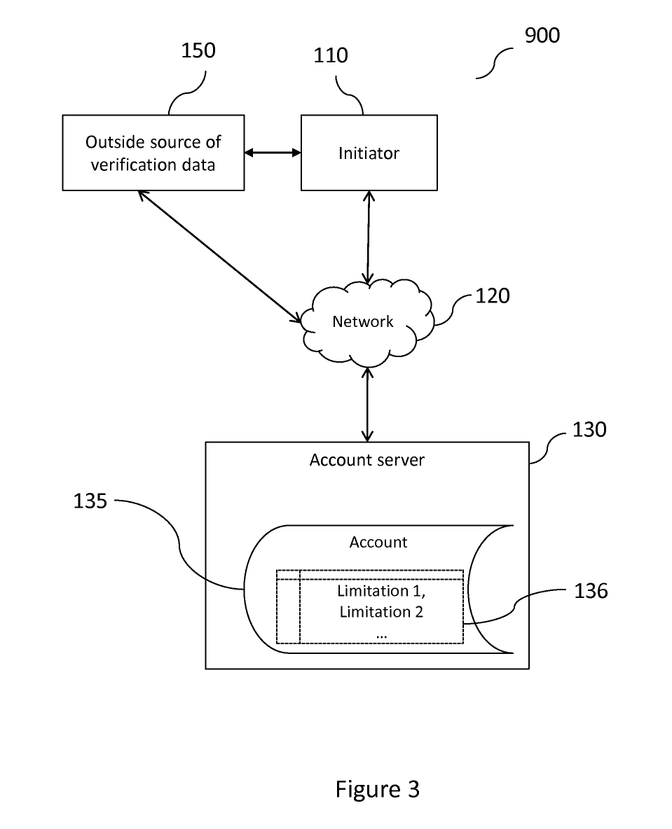

The configuration method described in FIG. 2 may utilize access to outside sources to simplify the verification process. Shown in FIG. 3 is a block diagram 900 of a system that includes an outside source of verification data 150, which can communicate to the initiator 110 directly and/or through the network 120. The outside source 150 also communicates with the account server 130 through the network 120.

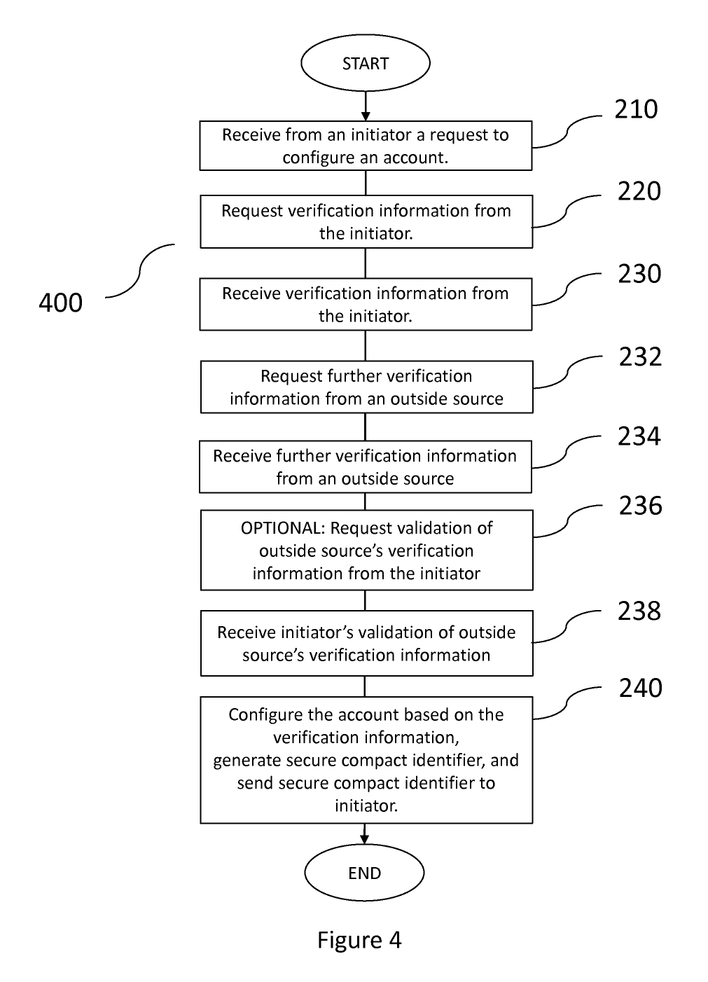

FIG. 4 shows a flowchart 400 illustrating how the system 900 illustrated in FIG. 3 would operate. As in FIG. 2, the initiator 110 sends a request to configure an account to the server 130 in step 210, and the server requests verification information from the initiator in step 220. The server receives verification information in step 230; this verification information may include a key that allows the server to request information from an outside source. For example, the initiator may send a user ID and a password so that the server 130 can access an outside financial account, or another account similarly configured with extra verification information. In step 232, the server 130 uses this information to request further verification from the outside source 150; for example, the server may request an account balance of an outside financial account, or it may request the verification information with which another, similar, account was configured. In step 234, the server 130 receives this additional verification information from the outside source 130. Optionally, in steps 236 and 238, the server requests that the initiator validate the information it has received from the outside source, and the initiator sends validation of this outside data. The account is configured, and a compact identifier is generated, in step 240.

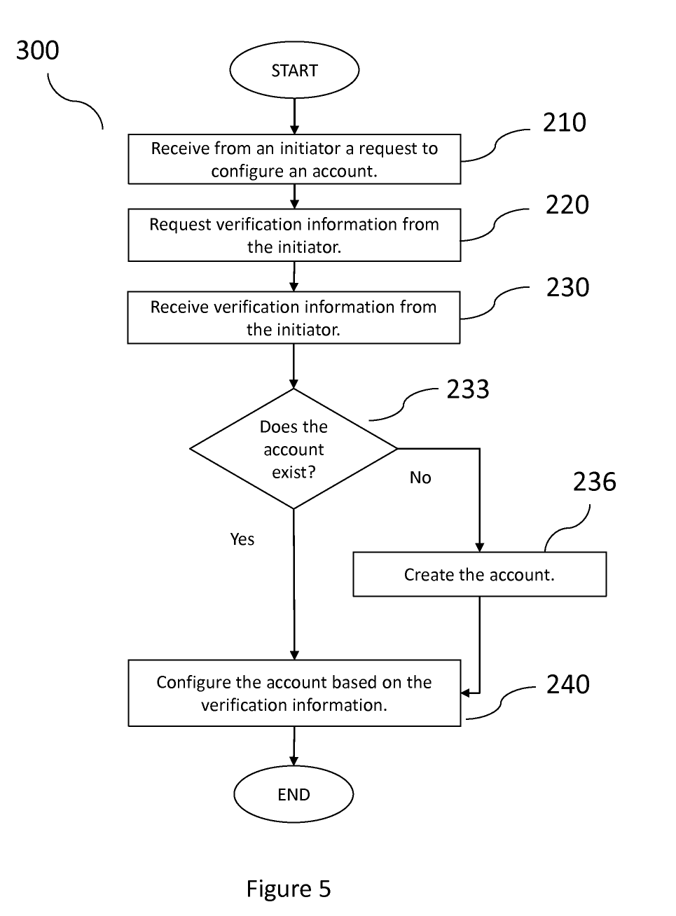

The configuration method described in FIG. 2 may be further refined. FIG. 5 shows a flowchart 300 of an account configuration process that accommodates initializing new accounts or re-configuring existing accounts. For example, the account holder (initiator) may desire to increase daily withdrawal limits on an existing account; he would therefore need to re-configure the account by submitting a more secure form of identity verification. In step 210, the account server 130 receives from the initiator 110 a request to configure a new account, or re-configure an existing account. In step 220, the account server 130 sends a request to the initiator 110 for verification information. Again, the request sent in step 220 may be in the form of, for example, a web site page that comprises a menu of different verification options and the account limitations to which they correspond. Again, this step may also include a request for a mobile phone number, as well as a request for a previously defined secure PIN, if the initiator wishes to modify an existing account, rather than create a new account. In step 230, the account server 130 receives the verification information from the initiator. In step 235, the account server 130 checks to see if the account exists; for example, by comparing the mobile phone number submitted with its database of existing accounts. If the account does not exist, it is created in step 238. In step 240, the account (new or existing) is again configured based on the verification information received in step 230.

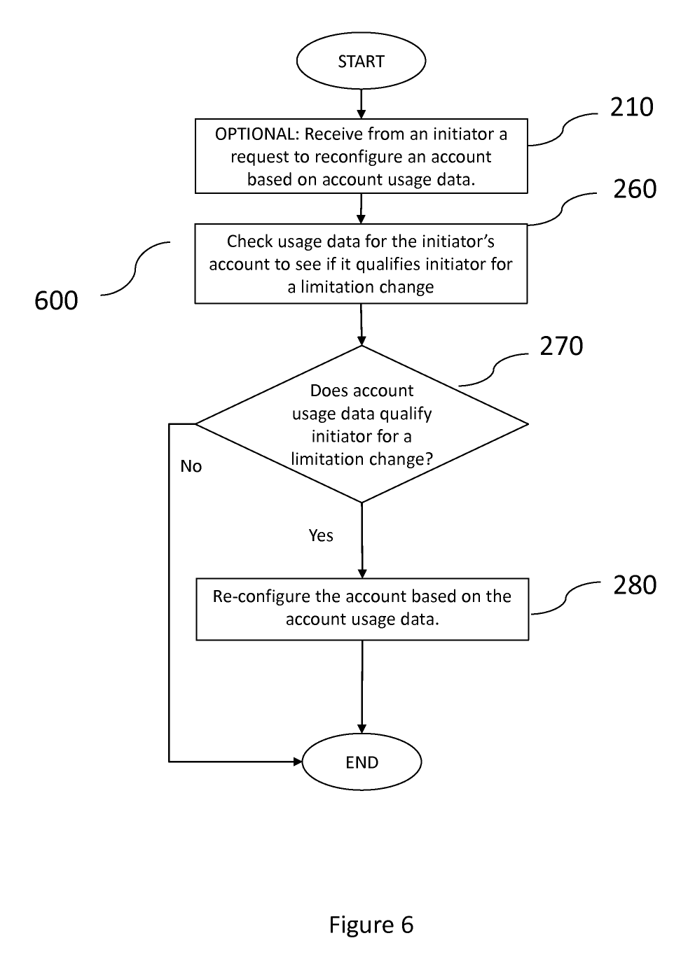

As another embodiment, existing accounts may be reconfigured based on account usage data; for example, on account transaction history or average daily account balances. FIG. 6 shows a flowchart 600 for such a method. In step 210 of FIG. 6, the initiator requests to reconfigure the account based on account usage data. Note that step 210 is optional; the flowchart 600 may be run automatically, thus periodically checking to see if the account can be refigured. For example, the server may check account usage every month to see if limitations may be upgraded, or if the need to be downgraded. In step 260, the usage data is checked to see if it qualifies the initiator for a change in limitations. For example, if the initiator keeps an average daily balance of more than $1000 for a month, then he may be eligible to increase his maximum withdrawal limit by $50. If the usage data qualifies the initiator for a change in limitations, the account is re-configured with the new limitations in step 280.

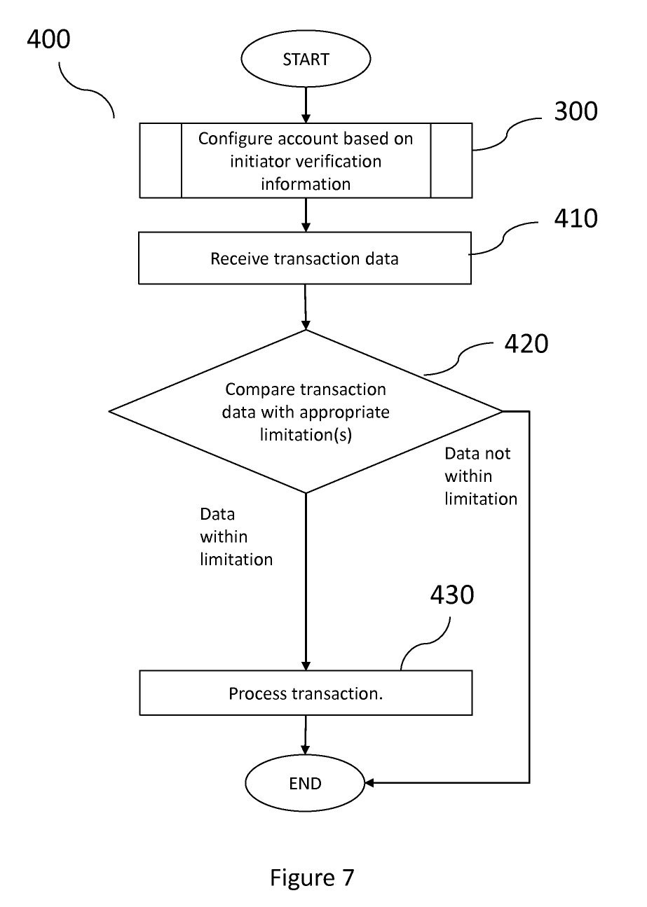

FIG. 7 shows an extended flowchart 400 of the configuration process, followed by the verification of a later transaction against the limitations set up during account configuration. Element 300 of FIG. 7 represents the account configuration process as described in any of the embodiments above. The account 135 is ready to accept transaction requests. In step 410, the account server 130 receives data for a transaction associated with the account 135. The data may be sent from, for example, the initiator, or from a merchant, or a combination of the two. This data may comprise, for example, the type of transaction, the amount of the transaction, and the transaction's currency.

As an example of such a transaction, the initiator may want to make a point-of-sale purchase. The merchant may send part of the transaction data—for example, the purchase amount—to the server. The initiator may then complete the purchase by sending to the server her secure PIN, for example. The server receives both pieces of this transaction data in step 410 of FIG. 7.

In step 420 of FIG. 7, the server compares the transaction data with the pre-configured limitations 136 associated with the account 135. In the point-of-sale purchase example, this comparison could comprise comparing the purchase price to the pre-configured maximum purchase amount associated with the account 135. If the transaction data falls within the pre-configured limits—for example, if the transaction price is below the POS purchase price limit—then the transaction is processed, as shown in step 430. If not, the transaction is not processed. In this case, the initiator may be given the opportunity (not shown) to provide other verification information in order to re-configure the account with increased limitations; in effect, repeating step 300 in FIG. 7.

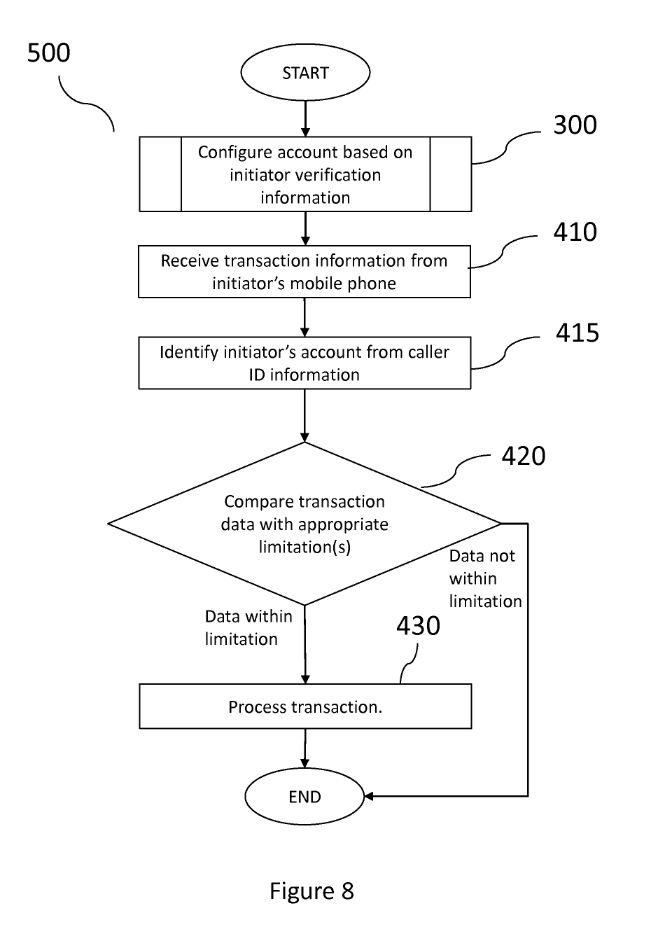

FIG. 8 shows a flowchart 500 detailing a variation on the extended process described in FIG. 7. Again, the configuration process 300 takes place, and the account 135 is ready to accept transaction requests. In step 410, the server 130 receives data for a transaction; all or part of this data is sent from the initiator's mobile device. In the point-of-sale example, the initiator may, for example, send her secure PIN from her mobile device via a text message. Again, some information about the transaction may be sent to the server by another party; for example, the merchant may send the purchase price information to the server. In step 415, the server uses caller ID information, including, for example, the initiator's mobile phone number, to identify the initiator's account. As before, the server compares the transaction data with the pre-configured limitations 136 associated with the account 135 in step 420, and the transaction is processed, if the transaction data falls within the pre-configured limitations for the account, in step 430.

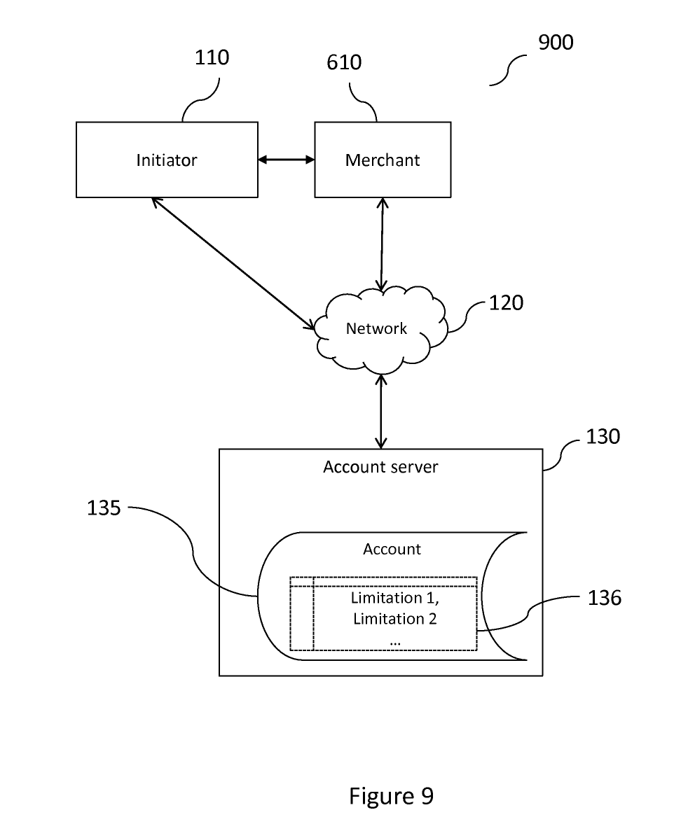

FIG. 9 shows a block diagram 900 of a point-of-sale transaction system using a pre-configured account. In this system, an initiator 110 makes a purchase from a merchant 610. Both the initiator 110 and the merchant 610 may transmit transaction information to the account server 130, via a network 120. For example, the merchant 610 may send the purchase price, and other product information, to the server 130 via a web-enabled device, and the initiator 110 may confirm the purchase, for example, by texting his secure PIN to the server 130 using his mobile device. Note that, in this example, the network 120 comprises multiple communication channels—the merchant 610 may use the Internet, while the initiator 110 uses a cellular network.

In the example illustrated in FIG. 9, once the account server 130 receives transaction data from the merchant 610 and/or initiator 110, the account server 130 may identify the initiator's account 135, for example, by using caller ID information. The server 130 then compares the transaction data to limitations 136 associated with the account 135, and, if the transaction falls within the limitations 136, the server 130 will process the transaction. At this point, the server 130 may send a message to the merchant 610, and possibly the initiator 110, indicating that the purchase has been approved (i.e., that the purchase price funds have been transferred to the merchant), and the merchant 610 may give the purchased product to the initiator 110. This notice of approval may, for example, be a web-based message sent to the merchant 610, and/or a text message sent to the initiator 110.

FIG. 9 may also represent a system wherein an initiator 110 withdraws cash from his account 135. In this case, the merchant 610 has a cash register. As described above, both the initiator 110 and the merchant 610 may send transaction information to the server 130, and, again, the server 130 uses this information, and the limitations 136 associated with the initiator's account 135, to approve or deny the transaction. If the transaction is approved, notice, again, is sent to the merchant 610 and possibly the initiator 110, and the merchant 610 can then hand the cash to the initiator 110.

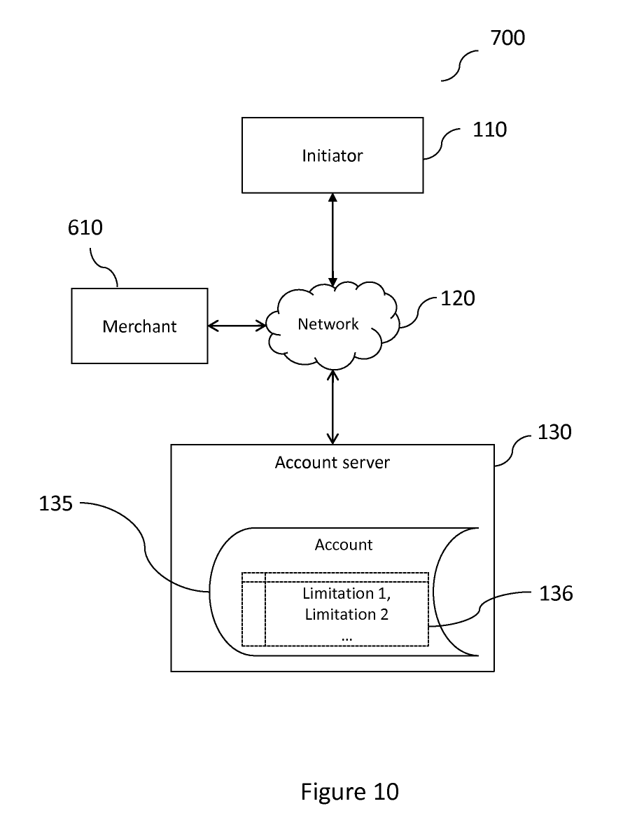

FIG. 10 shows a block diagram 1000 of an online transaction system using a pre-configured account. In this case, the initiator 110 makes an online purchase from the merchant 610, through, for example, the merchant's web site. The initiator 110 may access the merchant's web site on a stationary or mobile device, connected to a network 120; for example, the Internet. Both the initiator 110 and the merchant 610 may transmit transaction information to the account server 130 via the Internet. For example, after the initiator 110 chooses to pay for the purchase using her pre-configured account 135, the initiator may then be prompted by the web site to enter her mobile phone number and secure PIN. Again, the server 130 then compares the transaction data to limitations 136 associated with the account 135, and, if the transaction falls within the limitations 136, the server 130 will process the transaction. The server 130 may then send a confirmation message to the merchant 610 and the initiator 110, and the merchant 610 can ship the product to the customer. The confirmation message from the server 130 may be sent to the initiator 110 and merchant 610, for example, via an e-mail message.

For both of the systems depicted in FIG. 9 and FIG. 10, the server 130 may deny the purchase, if the purchase data does not fall within the limitations 136 of the pre-configured account 135. As described above for FIG. 7, the initiator 110 in this case may be given the opportunity to provide other verification information in order to re-configure the account with increased limitations. For example, for the on-line purchase case of FIG. 10, the initiator may be re-directed to a web site where he can re-configure his account, providing extra verification data, if necessary.

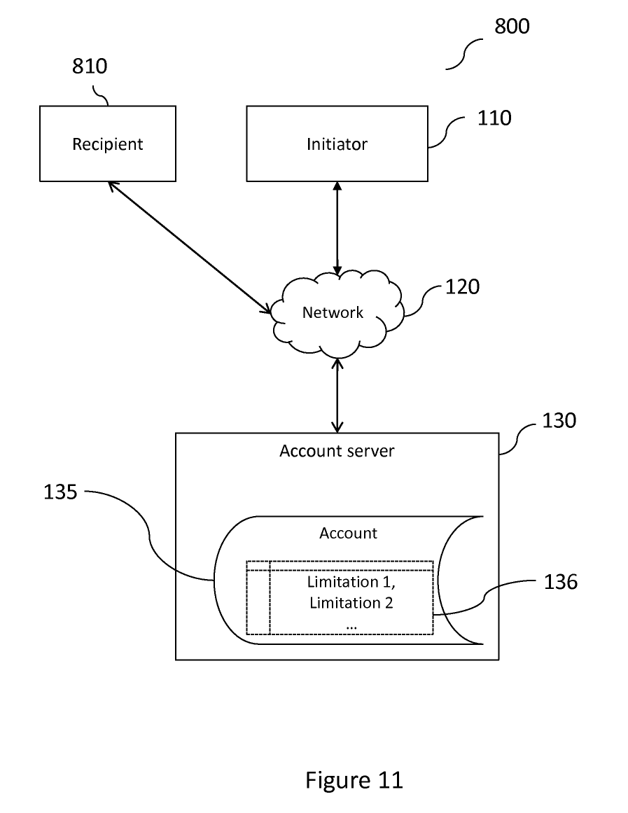

FIG. 11 shows a block diagram 800 of a peer-to-peer transaction using a pre-configured account exemplifying the present invention. In FIG. 11, the initiator 110 sends a remittance to a recipient 810. Both initiator 110 and recipient 810 connect to the account server 130 via a network 120, for example, a cellular network. The initiator may begin by sending transaction information and recipient information to the account server 130. This information may be sent, for example, in a text message, and may include, for example, the recipient's mobile phone number and the amount to remit to the recipient. The server 130 may identify the initiator's account 135 from, for example, the initiator's caller ID information. The server 130 then compares the transaction data to limitations 136 associated with the account 135, and, if the transaction falls within the limitations 136, the server 130 may proceed with the transaction. For example, the server 130 may then ask for additional verification information from the initiator 110 and recipient 810. When all verification procedures are completed successfully, funds may be transferred from the initiator's account to the recipient's account. If the recipient does not have an account, he may be prompted to create one.

As set forth above, the present invention provides a multi-step system to pre-configure, and re-configure, accounts to operate with different limitations on transactions. In one specific example, this system may operate in the following manner:
1. Computer code that controls the system to accept receipt of a request to configure an account for a later transaction. This request may be made from an initiator via a web site.
2. Computer code that controls the system to prompt the initiator for verification information. This prompt may be in the form of a menu of different verification options and their corresponding account limitations.
3. Computer code that controls the system to accept receipt of the initiator's verification information. This may consist of:
   a. Accepting the initiator's choice of a configuration option;
   b. Prompting the initiator for the appropriate verification information; for example, the initiator's mobile phone number, and a photograph or a scan of the initiator's passport;
   c. Accepting the initiator's identity verification information; for example, an uploaded photograph of the initiator's passport, taken with the camera built into the initiator's computer.
4. Computer code that controls the system to check if an account exists for the initiator; if not, then the computer code instructs the system to create a new account.
5. Computer code that controls the system to configure the newly created, or existing, account with the limitations associated with the verification information provided by the initiator, and to generate a secure, compact identifier (for example, a secure PIN) that the initiator will use in later transactions. Alternatively, the system may send a request for a self-generated PIN to the initiator, and subsequently receive the initiator's PIN.

The system as set forth herein also provides methods to verify later transactions with the pre-configured limitations described above. In one specific example, this system may verify transactions in the following manner:
1. Computer code that controls the system to accept receipt of a data for an active transaction on the account; this may be, for example, for a point-of-sale purchase, where a merchant sends purchase price information to the server, and the initiator (purchaser) sends her compact identifying information to the server, via her mobile phone.
2. Computer code that controls the system to identify the initiator's account, using the initiator's caller ID information.
3. Computer code that controls the system to compare the transaction data with the account's limitations; for example, the system may compare the purchase price with the pre-configured POS purchase price limits on the account.
4. Computer code that controls the system to process the transaction if the transaction data is within the limitations; for example, if the purchase price is less than the POS purchase price limit set for the account. In this example, the code then may control the system to notify the merchant and initiator of the successful transaction.

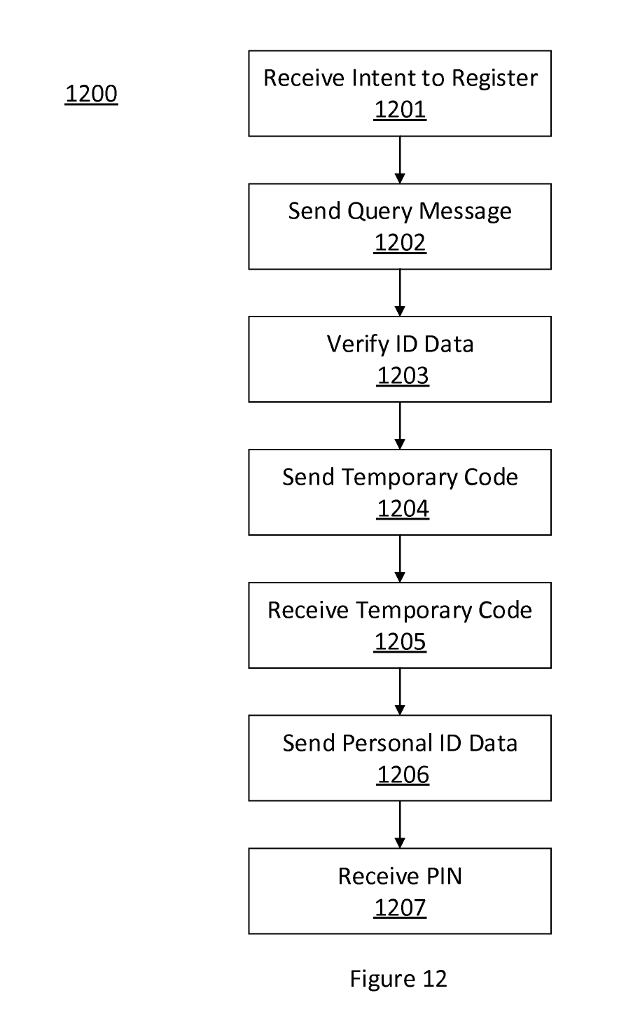

A specific implementation of the account creation method described with reference to FIG. 2 can be described with reference to FIG. 12. FIG. 12 illustrates a method 1200 for creating an account that is convenient for users (e.g., account applicants) and doesn't require the user to have access to expensive or complex technology. This is because the request to configure the account associated with step 210 can be conducted using a basic mobile telephone that is limited to SMS and voice functionality (i.e., the phone doesn't have to be a smart phone). According to a report by the World Bank, nearly three quarters of the world's population has access to telephones with this degree of sophistication, the method is widely applicable and therefore has the potential to provide payment services with low per person costs to a broad array of potential users. At the same time, the steps of requesting verification information 220 and receiving verification information 230 are conducted using more efficient and technology intensive procedures than SMS messaging but place the burden of this more intensive technological burden on the service provider side of the system which again assures that the user only needs access to the most basic technology to set up an account. Finally, the step of configuring the account based on verification information and generating the secure compact identifier 240 is conducted using a trusted merchant or clerk that can verify the account in person. The overall procedure thereby provides a convenient and widely accessible payment registration procedure while still providing the payment service provider with sufficient protection from fraudulent registrations.

In step 1201, an intent to register message is received from a user via an SMS messaging service. The message could be received by account server 130 via network 120. The user could be initiator 110. The intent to register message could be provided in response to a prompt advertised by the payment service provider. The prompt could have also been provided by a financial institution at which the user is already an account holder. The intent to register message could be as simple as a text including the letters “REG” sent to a given telephone number. The intent to register message could also include the user's mobile phone number or some other kind of personal information from which the user's mobile phone number could be accessed from a mobile operator's database or the database of a financial institution at which the user was already an account holder.

In step 1202, a query message is sent to the user to request verification information from the user. For example, the query message could be a request for a government identification number such as a driver's license number, a tax payer identification number, or a social security number. The query message can be delivered through various channels. For example, the query message could be delivered via a live customer service representative calling the mobile phone from which the user sent the intent to register message. As another example, the query message could be delivered via an automated telephone system that communicates with the user via a touch pad interface on the user's phone or an interactive voice response system.

The information requested by the query message can take on various forms. The query message could request a different kind of personal identification information and is not limited to government identification numbers. For example, the information could be a user's date of birth, mobile telephone number, first and last name, or any other kind of personal information that might be used to identify an individual. The kind of information that is requested by the query message will depend on the implementation. However, it is likely that in situations in which unbanked users are the target of a marketing effort, it will be beneficial to request more sensitive identification information at this early stage in the registration process. There are two reasons why more sensitive information can be requested at this stage in this particular implementation. First, unbanked users are less risk averse to identity theft and are therefore more willing to provide sensitive information when prompted. Secondly, the risk of fraud is greater with users that cannot prove a connection to a financial institution or established credit, and providing more sensitive information can generally provide a greater degree of security to the payment service.

In step 1203, the government identification number or other personal identification information is verified against a collection of data entries provided by a third party. For example, the data entries could be in a government curated database to which the payment service has access. With reference to FIG. 3, the government curated database could be outside source of verification data 150 which is accessed by account server 130 via network 120. The data entries could also be in a database that was uploaded in bulk to the payment service by a third party such as a financial institution that was planning on registering all of their account holders to the payment service. For example, a local bank could provide a bulk upload of customer data to the payment service provider such that verification of their existing customers could be made more convenient. As another example, the data entries could be held in a database curated by a credit monitoring facility to which account server 130 has access via network 120.

Verification step 1203 could also involve pulling additional identification information for a user from a third party database. In embodiments where a government identification number or other personal identification number is verified against a third party database, additional identification information relating to the verified user could be downloaded from the database and stored locally by the payment service. The downloaded personal information could be stored in account server 130 as an entry associated with a particular user's account. For example, after verifying a tax payer registration number against a government database, a picture of the verified user could be downloaded and stored in account server 130. As another example, after verifying a bank account number against a financial institution database, the full name and date of birth of the verified user could be downloaded and stored in account server 130.

In step 1204, a temporary validation code is sent to the user via an SMS messaging service. The temporary validation code can be any alphanumeric code that can be delivered via text messaging. The code could be all numbers or all letters. The temporary validation code may allow the user to conduct a limited set of transactions with their account. For example, the temporary validation code may be used to initiate a deposit into the account or transfer a preset amount from the account that was offered as an inducement to register. However, certain advantages accrue to versions of process 1200 in which the temporary validation code can only be used to initiate a second stage of the registration process from a trusted terminal. The temporary code could be delivered with simple text instructions for completing the registration procedure. As a specific example, the temporary code could be delivered with an address of a point of sale terminal that is operating in accordance with the payment service that is located in the same general location as the one from which the initiation request was sent.

Returning to FIG. 12, the temporary validation code is received via a known point of sale terminal in step 1205. As an example, a user with a temporary validation code wishing to complete their registration process could enter a store, pay center, or bank with a known point of sale terminal, and enter their temporary validation code to move forward with registering their account. As another example, a user with a temporary validation code could attempt to purchase an item at a store that accepts the payment service and thereby provide their temporary validation code as part of the payment flow for that item. As another example, a user with a temporary validation code wishing to add money to their account could attempt to do so using a known point of sale terminal and thereby provide their temporary validation code as part of the add money flow for that transaction. When prompted, the user could enter the temporary validation code into the known point of sale terminal.

The point of sale terminal used in combination with step 1205 can be referred to as a “known” point of sale terminal because it has been preconfigured to operate with the payment service or to be operated in accordance with policies set by the payment service operator. The point of sale terminal could indeed be produced in accordance with specifications set by the operator of the payment service and be provided to merchants, pay centers, or banks to process payments using the payment service. The point of sale terminal could also be a standard point of sale terminal that was specially configured with software to make the terminal compatible with the payment processing service. Finally, the point of sale terminal could be a standard point of sale terminal that has not been specifically modified to work with the payment service, but that is configured to authenticate itself to the payment service such that the specific terminal can be identified and trusted.

The point of sale terminal can take on various forms. For example, the point of sale terminal could be a simple solitary unit having a key pad and small monitor for displaying data to a user. Furthermore, although the point of sale terminal has been referred to using the singular form, this is not meant to exclude systems having two different physical device. For example, a known point of sale terminal could comprise a first interface for a clerk or merchant on one physical housing, and another interface for a user located on another physical housing.

The use of a known point of sale terminals decreases the risk of fraudulent registrations. Since the payment service can have a special relationship with the operator of the point of sale terminal, a higher level of security is provided to the registration process. The operators of the point of sale terminals can be prescreened by the payment service. Furthermore, the payment service may require the point of sale terminal to be used only at a specific physical location to assist in tracking down fraudulent usage of the terminal. The payment service could also mandate certain levels of surveillance at the location in which the terminal is being operated at a condition of offering the payment service to people that bank or shop at that location. The added level of protection afforded by a known point of sale terminal offers additional benefits which become more apparent as the registration procedure is described in more detail below.

In step 1206, personal identification information is sent to the known point of sale terminal. The purpose of delivering this information is to allow the operator of the point of sale terminal to verify the identity of the user in order to move forward with the registration process. The information sent to the terminal could be the information that was collected during the initial portion of the registration procedure in response to the query message sent in step 1202. The information sent to the terminal could be information that was provided directly by the user in response to the query, or it could be information that was accessed based on the information provided by the user during verification step 1203. For example, the user may have provided a driver's license number in response to the query, and the same number could be delivered to the known point of sale terminal in step 1206. As another example, the user may have provided a government identification number which was used to access other personal identification information such as the user's name and date of birth, and that other personal identification information could be delivered to the known point of sale terminal in step 1206. The information could also include a picture of the user, biometric data associated with the user, or identification information already being used by another entity to identify that particular user such as a store affinity account number.

The disassociation of the information provided by the user in the initial phase of the registration procedure and the information provided to the point of sale terminal for the second phase of the registration procedure provides significant benefits. Since the point of sale terminal is secure, the payment service can deliver this personal information for verification without exposing the user to the risk of identity theft. Furthermore, the fact that the government identification number can be used to access less sensitive data will provide the payment system operator with the security of knowing the user had access to that more sensitive information while the operator of the point of sale terminal is not provided access to that information. Thereby, a high degree of security is provided to the payment service provider while also providing a high degree of security to the user because any operator in the network of the payment system is not provided with the more sensitive identification information.

The verification procedure performed by the operator of the point of sale terminal will depend on the kind of information that is delivered to the point of sale terminal. For example, if the information delivered is a driver's license number, the verification procedure will involve the operator physically inspecting the user's license and confirming their identity via an interface presented by the point of sale terminal. If the information delivered is a user's full name and date of birth, the verification procedure will involve the operator physically inspecting any suitable form of identification that can confirm the user is the same person as was identified in the first phase of the registration procedure.

Returning to FIG. 12, an updated personal identification number is received from the known point of sale terminal in step 1207. After the operator has verified the identity of the user based on the information provided to the known point of sale device, the operator will trigger a procedure requiring the user to specify a compact identifier such as a personal identification number (PIN) that the user will be able to apply to authorize all of their future transactions using the payment service. Effectively, the procedure will allow the user to exchange their temporary validation code for a permanent PIN that can be used with the payment system. The transfer of the PIN from the point of sale terminal to the account server can be encrypted to protect the number from being intercepted. In addition, the interface of the point of sale terminal can block out the numbers of the PIN as it is being typed to prevent unscrupulous parties within sight of the interface from seeing the PIN. The series of interface elements that are delivered to the user in order for the user to set their PIN will generally not be made available to the user until the operator of the point of sale terminal has verified the identity of the user. For example, the personal identification data delivered to the terminal may be a driver's license number of the user, and the PIN creation sequence will not be offered by the point of sale terminal until the operator of the point of sale terminal physically inspects the user's license and determines that the user is the same person that was identified during the first phase of the account registration procedure. After this personal identification number is received and stored, the registration procedure for the user will be complete.

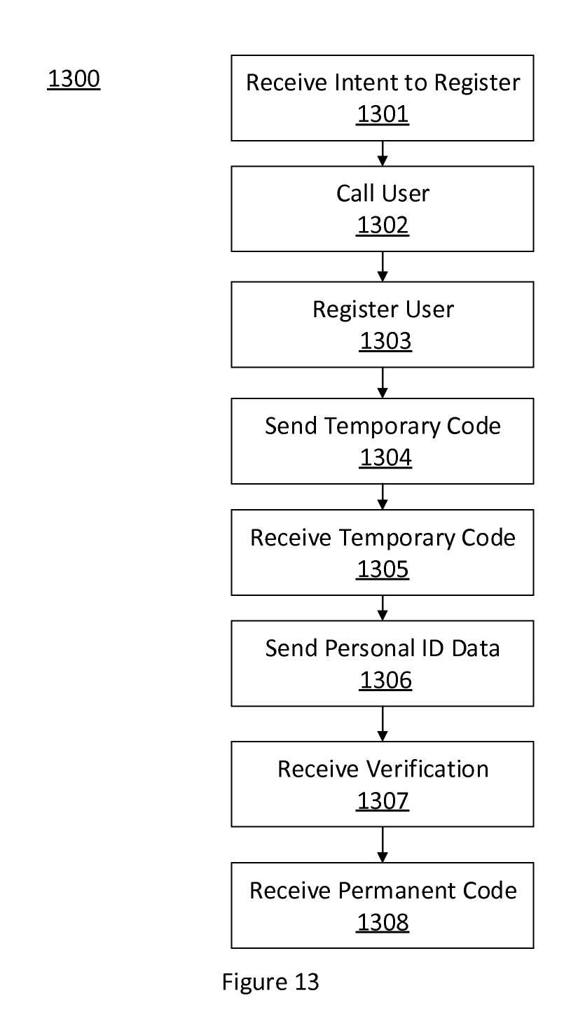

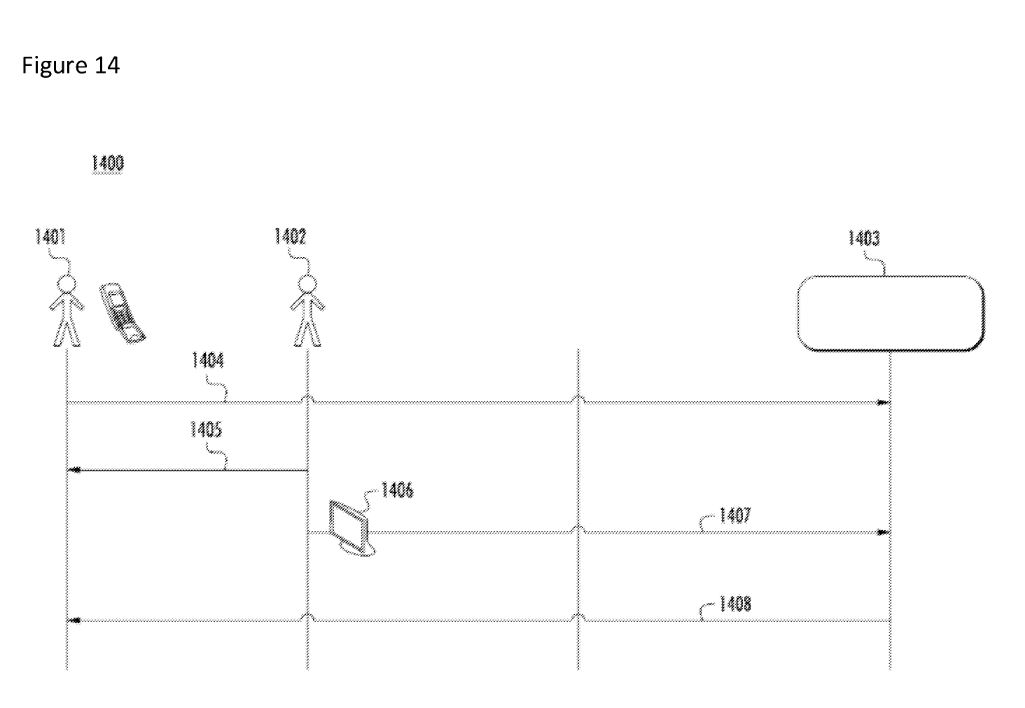

A process for registering a user for a payment service in which the initial request for information to the user is sent via a telephonic voice channel can be described with reference to FIGS. 13 and 14. FIG. 13 displays a process 1300 for verifying a user for a payment system. FIG. 14 displays an operation diagram 1400 of the associated interactions between potential account holder 1401, customer service representative 1402, and payment service platform 1403. In step 1301, an intent to register message is received from a user via a text message system. The text message system can be utilized by any phone having basic text messaging capability, and does not require the phone to have email or more complex messaging capability such as a specialized application for communicating with the payment service. An example of this step is shown as operational flow line 1404 in FIG. 14 showing the operational connection between potential account holder 1401 and payment service platform 1403.

In step 1302 of process 1300, a live customer service representative will call the user to obtain personal information from the user and continue the registration process. The personal information can comprise KYC details necessary for complying with money laundering or commercial payment processing regulations. An example of this step is show as operation flow line 1405 in FIG. 14 showing the operational connection between customer service representative 1402 and potential user 1401. Customer service representative 1402 will know to contact account holder 1401 because of a notification generated by payment service platform 1403. For example, the payment service platform may update a task list for customer service representative 1402 or it may automatically initiate a phone call from a phone assigned to customer service representative 1402 to the potential user 1401 such that the customer service representative has a continuous queue of potential users to call. The potential user's phone number could be stripped from the intent to register message, it could be provided by the user and entered as part of the text message itself, or it could be identified by payment service platform 1403 based on other identifying information provided in the text message from the user.

In step 1303, the customer service representative will register the user with the payment system using the personal information obtained from the user via telephone. An example of this step is shown as operation flow line 1407 in FIG. 14 showing the operational connection between customer service representative 1402 and payment service platform 1403. The operational flow diagram includes portal 1406 because the personal information obtained from potential user 1401 can be entered by customer service representative 1402 using various portals such as a web-based portal. Specific benefits accrue to situations where portal 1406 is a standard web portal that is available to the general public via the Internet. User 1401 might not have access to a sophisticated device that can instantiate a web portal for the convenient entry of the personal information necessary to establish an account. However, other potential users of the payment service may be able to register for the payment system using a different method that focuses instead on a user directly entering their personal information via a web portal. The overall payment system can achieve a significant decrease in per-user costs if the same web portal is used for registering both kinds of potential users. In effect, customer service representative 1402 will be loaning account holder 1401 the use of portal 1406 for an extremely brief period—just long enough to collect the required personal information from potential user 1401 without having to put user 1401 through the awkward process of entering long strings of personal information in the limited user input interface of a basic mobile phone.

Once the personal information has been entered by the customer service representative, the payment service will send a temporary validation code to the user via text message in step 1304. An example of this step is shown as operational flow line 1408 in which the temporary validation code is sent from payment service platform 1403 to user 1401. Customer service representative 1402 could also receive the temporary validation code information via portal 1406 and convey the information over the telephone to user 1401. However, certain benefits accrue to a process in which the temporary code is sent directly to the user via SMS. First, the temporary authorization code will be sent to the mobile phone of the user which will provide an added degree of certainty to assure that the person that is conducting the registration process is the same person as the person whose name the account is being opened in. Secondly, the customer service representative will not be exposed to the temporary registration code even though they are using the same portal that a user opening an account in their own name would utilize. This provides another degree of security to the potential user and also enhances the utility of using the same web portal for registering users directly and through customer service representative 1402.

Returning to FIG. 13, process 1300 handles the second phase of the registration process similarly to how the second phase of the registration process was described with reference to FIG. 12. In step 1305, the temporary registration code is received from the user via a preapproved point of sale terminal. As described above, the user could be attempting to purchase something using the payment system, add money to the account, or conduct some other kind of transaction involving the payment system including simply attempting to register the account. In step 1306, a portion of the personal information collected in step 1302 will be provided to the terminal to facilitate the verification of the user's identity by the operator of the terminal. In step 1307, a verification is received from a terminal operator that confirms that the user matches the KYC details obtained in step 1302. This step could involve, as described above, the operator confirming the information delivered to the terminal against a physical form of identification provided by the user. The step could also involve the operator querying the potential user to verbally provide matching information to the operator. These approaches would generally require the interface on which the personal information was delivered to be isolated from the potential user. In step 1308, a permanent registration code is provided by the user to the payment system to be used by the user to conduct further transactions using the payment system via the same point of sale terminal on which the personal information was provided. The permanent registration code could be elected by the user or selected randomly by the point of sale terminal and delivered to the payment service.

Process 1300 and 1200 could also include issuing a near field communication (NFC) tag to the user. The NFC tag could be associated with a merchant's promotional program or it could be provided to the operator of the point of sale terminal by the payment service provider. The NFC tag could be encoded at the point of sale terminal such that it stored the permanent PIN provided by the user. The user would then be able to enter their PIN at a point of sale terminal simply by swiping their NFC tag near a reader. In the alternative, the permanent PIN could be an identifier associated with the NFC tag that was not configurable by the user. The NFC tag could, for example, have a number burned into it when it was manufactured or prior to being delivered to an end user. This number would be provided by the operator at the point of sale terminal while the final portion of the registration was being completed such that the number would be associated with the user and stored in a payment service database. This approach could provide certain benefits because the numbers associated with the NFC tag could be locked from access until the registration procedure was completed such that no one would be able to obtain the NFC tag's number before it was issued to the user. For example, the NFC tag identifier would be swiped by the point of sale terminal operator and the associated number would be sent to the payment service in step 1308 without the terminal operator ever seeing the associated identifier.

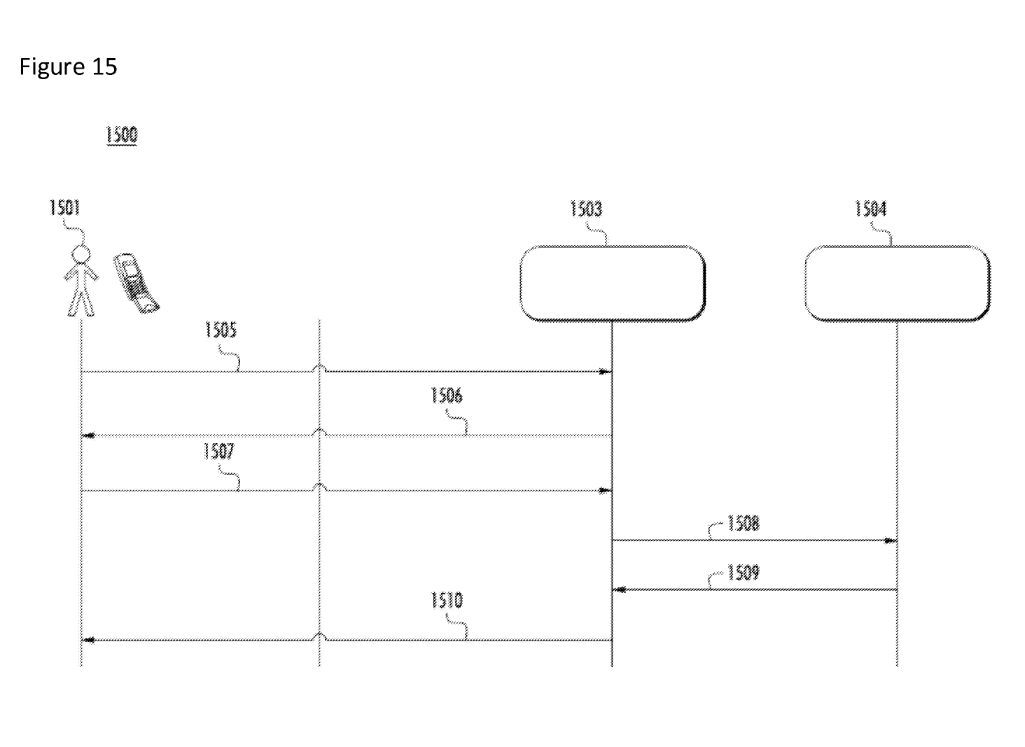

An implementation of process 1300 can be described with reference to FIG. 15. FIG. 15 displays operational flow diagram 1500 in which a registration process is carried out without the use of a live customer service representative. This procedure can provide additional per user cost benefits to the payment service because the automated system can add users to the system more rapidly and does not require a human employee or contractor. Operation flow diagram 1500 displays the operational connections between potential account holder 1501, point of sale terminal 1502, payment service platform 1503, and outside validation database 1504.

Processes illustrated by flow diagram 1500 differ most notably from those in flow diagram 1400 because flow lines 1405 and 1407 have been replaced with flow lines 1506 and 1507. Operational flow line 1505 can involve the same intent to register messages that were discussed with reference to flow line 1404. However, operational flow line 1506 involves a call from an automated system controlled by payment service platform 1503 to user 1501 instead of a call from a live customer service representative. The automated system can trigger a phone call immediately after processing the intent to register message or it can place calls according to a specified schedule such as when a cost of air time is at a minimum. Operational flow line 1506 will involve a request for a government identification number or some other form of personal identification information. For example, the request could be for a taxpayer reference number or a social security number. Operational flow line 1507 involves the delivery of the requested information from potential user 1501 to payment service platform 1503. The information could be provide by user 1501 entering the information via a key pad or via an interactive voice response system.

After operational flow line 1507, flow diagram 1500 could move on to various illustrated steps. For example, if the information obtained in step 1507 was safe to transmit directly to a point of sale terminal, the information could be stored for the next phase of the registration process and the procedure could move directly to step 1510 in which a temporary registration code was delivered to user 1501 via payment service platform 1503. The information sent in accordance with this operational flow line could match the information sent in accordance with operational flow line 1408. If the information provide in step 1507 needed to be verified to meet KYC requirements, or it needed to be used to access a database to obtain a different set of personal information, the operational flow could continue with operational flow line 1508. In operational flow line 1508, the information provided in operational flow line 1507 is sent from payment service platform 1503 to outside database 1504. For example, the information obtained in step 1507 could be a taxpayer registration number, and outside database 1504 could be a government curated database. In operational flow line 1509, additional personal information identifying the user could be downloaded from outside database 1504 for the payment service platform 1503. This information could include a full name of a potential user and the user's date of birth. However, additional information does not need to be provided by outside database 1504, and operational flow line 1509 could simply comprise an acknowledgment verifying the data provided in operational flow line 1508. Note that operational flow diagram 1400 could have also included an outside database that would be used by the payment service platform 1404 between operational flow lines 1407 and 1409, but it was omitted in that diagram to emphasize other features of that particular process.

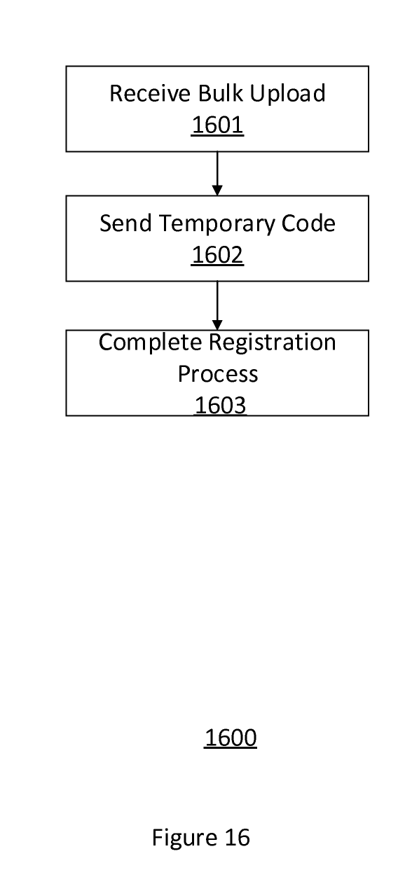

A process 1600 of the bulk registration of potential users of the payment system can be described with reference to FIG. 16. Process 1600 includes a step 1601 of receiving a bulk upload of user identification information from a participant financial institution. By uploading the data, the financial institution is participating in the payment service and is interested in moving their customers to the payment service or at least wants to offer the payment service to its customers as an option. The bulk upload could be provided by a secure network connection between the payment system servers and the financial institution's servers. The bulk upload could also be provided via an outside verification source such as 150 and be provided to account server 130 via network 120. The bulk upload could be provided by a government entity or company interested in providing certain people that are affiliated with the entity or company an account with the payment service. For example, a government entity may want to provide an account to social welfare recipients or a company may want to provide an account to its employees. The user identification information can include the names and account numbers of the users. The user identification information could also include a set of mobile phone numbers associated with each of the users.

Process 1600 continues with step 1602 in which a temporary validation code is sent to each of the users for which identifying information was provided to the payment service in step 1601. The temporary validation codes could be sent via text message to the users. If mobile phone data was provided in step 1601, that mobile phone data could be used to send the text messages in step 1602. In specific implementations of process 1600, the temporary validation code could be sent to a limited subset of the users for which bulk upload information was provided in step 1601 such as only those users for whom a mobile telephone number was provided.

The temporary validation code could be sent along with an incentive to register for the payment system. The incentive could be sent in the same text message as the temporary validation code. The text message could include an offer for a monetary payment to be redeemed in cash upon providing the temporary validation code at a location having a known point of sale terminal. The text message could also include an offer for a temporary reduction in transaction fees using the payment service. The text message could also include an offer for participation in a lottery in which each new registrant to the payment system in a limited amount of time was a participant in the lottery. The prize in the lottery could be money deposited into the payment service account associated with the winning participant.

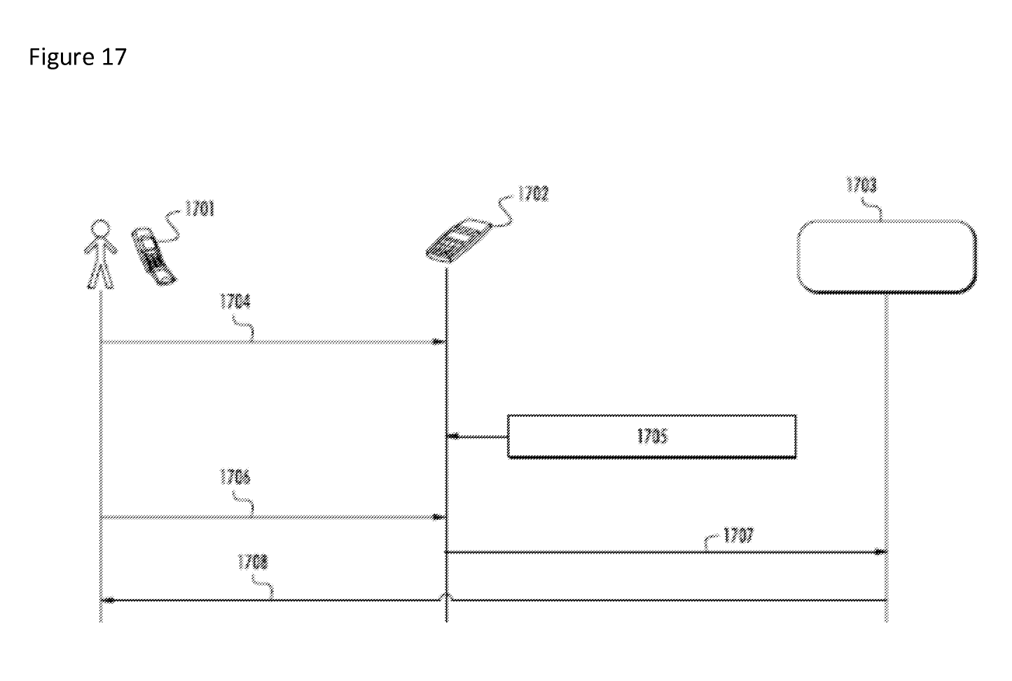

Process 1600 will then progress with steps that are largely in accordance with steps 1205, 1206, and 1207 from process 1200 or steps 1305, 1306, 1307, and 1308 from process 1300. These steps are represented collectively by step 1603 in process 1600. Corresponding steps are illustrated by operational flow diagram 1700 in FIG. 17 which shows the second phase of a registration procedure involving a user 1701, a point of sale terminal 1702, and a payment service platform 1703. Flow diagram 1700 begins with operational flow line 1704 in which an account holder initiates a purchase, cash withdrawal, or add money transaction. This is followed by process 1705 in which a point of sale terminal operator verifies the identity of the user using identification information provided to the point of sale terminal with information provided by user 1701. If the identity of the user is verified, the point of sale terminal operator allows the operation to continue with operational flow line 1706 in which a permanent PIN is created at the point of sale terminal by user 1701. This can include being issued an NFC tag with a predetermined PIN number or the entry of a personalized number by the user on a keypad of the point of sale terminal. Next, the permanent pin is sent from point of sale terminal 1702 to the payment service platform 1703 as shown by operational flow line 1707. This step can involve the PIN being entered by the user and sent securely to the payment service platform 1703 or it can involve an NFC tag identifier being read by an NFC reader on point of sale terminal 1702 and securely sent to the payment service platform 1703. Finally, a confirmation message may be sent to the user via SMS confirming that their account has been created. This final step is illustrated by process flow line 1708.

After the new user is registered with the system, the user may be able to use the payment system in combination with an account held by the financial institution from which their data was provided. For example, any payment using the payment system after registration could involve sending an authorization to the point of sale terminal that confirmed the account with the financial institution had sufficient funds or credit to be able to affect payment. Other kinds of account associated with the payment system could also contain funds or credit as soon as they are registered. For example, a government entity may have provided funds to an account associated with the payment system so that the money would be available to the account holder as soon as they registered with the system. Likewise, any entity providing the bulk upload information could have pre-set accounts with funds or credit for the potential users of the payment system such that the accounts could instantly be used to conduct transactions as soon as a user completed registration. Effecting payment for the transaction could include transferring funds between accounts in real time. Effecting the payment could also include providing an authorization and then transferring funds between accounts at a later time during a batch settlement process involving the terminal operator, the payment service, and the financial institution.

The above description illustrates various embodiments along with examples of how aspects of the present invention may be implemented. For example, direct communication, U.S. mail, phone calls, text messages, data messages or e-mail through wired or wireless voice or data channels, encrypted or not encrypted, and the like may all be considered communication means. A mobile device may be a mobile phone, two-way pager, tablet or notebook computer, and the like. A compact identifier may be a PIN, or a pseudorandom code, or the like. Secure identity verification may be a photograph of one of the transacting parties, or a photograph of identification documents, such as a passport, license, or utility bill, or the like, or biometric information such as a fingerprint or retinal scan.

The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

1. A process for facilitating the registration of a user of a payment service comprising:
receiving by a computer an intent to register message from a user via an SMS message sent from a user mobile device, said user mobile device being associated with said user;
sending by the computer a query message to said user mobile device, said query message including a request for a government identification number from said user;
verifying by the computer said government identification number against a collection of data entries provided by a third party;
sending by the computer a temporary validation code to said user mobile device;
receiving by the computer an updated PIN from a known POS terminal, said known POS terminal having been previously registered with said payment service, and said updated PIN replacing said temporary validation code; and
sending by the computer a registration confirmation to said user mobile device.

2. The process of claim 1, wherein said query message is sent telephonically by a live payment service customer service representative.

3. The process of claim 2, further comprising:
receiving by the computer said government identification number through a registration page of a consumer web portal of said payment service;
wherein said registration page is publically available via the Internet.

4. The process of claim 2, wherein said payment service customer service representative triggers a payment service platform to send said temporary validation code after said government identification number is verified against said collection of data entries.

5. The process of claim 1, further comprising:
receiving by the computer said government identification from said user via an interactive voice response system;
wherein said query message is sent telephonically by an automated call service.

6. The process of claim 1, further comprising:
receiving by the computer said temporary validation code via said known POS terminal; and
sending by the computer said government identification number to said known POS terminal in response to receiving said temporary validation code.

7. The process of claim 1, further comprising:
receiving by the computer said temporary validation code via said known POS terminal; and
sending by the computer personal identification information for said user to said known POS terminal in response to receiving said temporary validation code.

8. The process of claim 1, further comprising:
receiving by the computer said data entries in a bulk transfer from said third party;
wherein said third party is a financial institution.

9. The process of claim 1, further comprising:
providing a collection of NFC tags to an operator of said known POS terminal;
storing by the computer an association between said user, one of said NFC tags, and said updated PIN in a database.

10. The process of claim 1, wherein:
said collection of data entries are in a government curated database; and
verifying said data entries involves accessing by the computer said database.

11. The process of claim 10, further comprising:
downloading by the computer personal identification information of said user from said government curated database;
receiving by the computer said temporary validation code via said known POS terminal; and
sending by the computer said personal identification information for said user to said known POS terminal in response to receiving said temporary validation code.

12. A process for verifying a user for a payment system comprising:
receiving an intent to register message from a user mobile device via a text message system, said user mobile device being associated with a user;
calling said user to obtain know your customer details;
registering said user using for said payment system using said know your customer details;
sending a temporary validation code to said user mobile device;
receiving said temporary validation code from said user via a preapproved point of sale terminal;
sending at least a portion of said know your customer details to said preapproved point of sale terminal; and
receiving a verification from a terminal operator via said preapproved point of sale terminal;
wherein said verification confirms that said user matches said know your customer details.

13. The process of claim 12, wherein said know your customer details include a government identification number.

14. The process of claim 13, wherein said government identification number is checked against a national database.

15. The process of claim 12, wherein:
said registering said user is conducted using a web portal; and
said web portal is available to the general public via the Internet.

16. The process of claim 15, further comprising:
receiving a permanent registration code from said user via said preapproved point of sale terminal.

17. A process for registering a group of users for a payment service comprising:
receiving by a computer a bulk upload of user identification information for said group of users from a payment service participant, said user identification information including a set of mobile phone numbers;
sending by the computer a temporary validation code to said users via a text message using said mobile phone numbers;
receiving by the computer said temporary validation code via a point of sale terminal;
registering by the computer said users for said payment system; and
receiving by the computer a permanent identification code for said users to operate said payment system via said point of sale terminal.

18. The process of claim 17, further comprising:
sending by the computer an incentive to register with said payment system in said text message;
wherein said incentive is selected from the group comprising: a monetary payment redeemable upon registration, entry into a lottery, and a temporary reduction in transaction fees.

19. The process of claim 17, wherein further comprising:
sending by the computer a payment authorization to said point of sale terminal, said authorization confirming a payment involving an account;
wherein said account was prefunded by said payment service participant.

20. The process of claim 17, wherein said payment service participant is a financial institution.

21. The process of claim 20, further comprising:
delivering by the computer at least a portion of said user identification information to said point of sale terminal; and
receiving by the computer a verification from an operator of said point of sale terminal, said verification confirming that said user matches said user identification information;
wherein said point of sale terminal is preapproved by said payment service.

22. The process of claim 20, further comprising:
sending by the computer a payment authorization to said point of sale terminal, said authorization confirming a payment involving an account at said financial institution;
wherein said payment is transferred from an account associated with said financial institution.

23. The process of claim 1, further comprising:
after the sending of the temporary validation code, receiving by the computer said temporary validation code via said known POS terminal.

24. The process of claim 17, further comprising:
before the sending of the temporary validation code, sending by the computer a query message to said user mobile device, said query message including a request for a government identification number from said user; and
verifying by the computer said government identification number against a collection of data entries provided by a third party.
